(19) United States
(12) Patent Application Publication
(10) Pub. No.: US 2025/0157135 A1
(43) Pub. Date: May 15, 2025

(54) ELECTRONIC DEVICE FOR DISPLAYING IMAGE, AND METHOD FOR CONTROLLING SAME

(71) Applicant: SAMSUNG ELECTRONICS CO., LTD., Suwon-si (KR)

(72) Inventors: Sungsoo CHOI, Suwon-si (KR); Beomsu Kim, Suwon-si (KR); Sungoh Kim, Suwon-si (KR); Donghyun Yeom, Suwon-si (KR); Jihyun Kim, Suwon-si (KR); Hyungsok Yeo, Suwon-si (KR); Boyoung Lee, Suwon-si (KR); Sanghun Lee, Suwon-si (KR)

(73) Assignee: SAMSUNG ELECTRONICS CO., LTD., Suwon-si (KR)

(21) Appl. No.: 19/025,567

(22) Filed: Jan. 16, 2025

Related U.S. Application Data
(63) Continuation of application No. PCT/KR2023/011911, filed on Aug. 11, 2023.

(30) Foreign Application Priority Data
Sep. 13, 2022 (KR) 10-2022-0114977
Oct. 31, 2022 (KR) 10-2022-0142723

(51) Int. Cl. G06T 15/20; G06F 3/01; G06T 5/60; G06T 5/80; G06T 7/60; G06T 7/90; G06T 19/00

(52) U.S. Cl. CPC G06T 15/20; G06T 5/60; G06T 5/80; G06T 7/60; G06T 7/90; G06T 19/006; G06F 3/013; G06T 2207/20081

(57) ABSTRACT

A wearable electronic device includes a camera; a display; a sensor; memory; and a processor configured to cause the device to obtain an image via the camera; perform pre-processing that calibrates a distortion area, of the image, generated from the camera; input, into a deep learning model, a default matrix related to a distance of an object in an image, first information input by a user, second information, obtained via the sensor, related to the user, or third information, obtained via the sensor, related to a surrounding environment; obtain, from the model, a matrix for adjusting the distance of the object; adjust the distance of the object based on the matrix; and display the image, wherein the model is trained based on user information or surrounding environment information, and at least one matrix for adjusting a distance of an object based on the user information or the surrounding environment information.

### CROSS-REFERENCE TO RELATED APPLICATION

This application is a by-pass continuation application of International Application No. PCT/KR2023/011911, filed on Aug. 11, 2023, which is based on and claims priority to Korean Patent Application No. 10-2022-0114977, filed on Sep. 13, 2022, and Korean Patent Application No. 10-2022-0142723, filed on Oct. 31, 2022, in the Korean Intellectual Property Office, the disclosures of which are incorporated by reference herein in their entireties.

### BACKGROUND

### 1. Field

The disclosure relates to an electronic device that displays an image and a control method thereof.

### 2. Description of Related Art

As electronic communication technologies have developed, electronic devices have been produced to be smaller and lighter so that users are able to wear them without great inconvenience. For example, wearable electronic devices such as head-mounted devices (HMDs), smartwatches (or bands), contact lens-type devices, ring-type devices, glove-type devices, shoe-type devices, or clothes-type devices are being commercialized. Since a wearable electronic device is worn directly on a body, portability and accessibility by a user may be improved.

A visual see-through head-mounted display (VST-HMD) is a head-mounted electronic device that is provided in the form of goggles. The head-mounted electronic device is a device worn on the head or face of a user for use, and may provide, in the form of images or text to the user, information associated with things in at least a part of the area in the user' field of vision.

A user who wears a VST-HMD wearable electronic device may be physically disconnected from the outside (closed-view), but may experience a genuine virtual reality (VR) rendered via an internal display. This type of electronic device may transfer, to an internal display in real time, a live video collected via a camera mounted in the front side, and may also enable a user to experience an augmented reality (AR) or mixed reality (MR) based on a real space.

The above-described information is merely provided to facilitate an understanding of the disclosure. There is no opinion or determination suggested as to whether any of the above descriptions are prior art related to the disclosure.

### SUMMARY

According to an aspect of the disclosure, a wearable electronic device includes a camera; a display; at least one sensor; memory storing instructions; and at least one processor configured to execute the instructions to cause the wearable electronic device to obtain a first image including at least one object via the camera; obtain a second image by performing pre-processing that calibrates a distortion area of the first image that is generated based on the camera based on information related to a type of the camera; input, into a deep learning model stored in the memory, at least one of a default matrix related to a first distance of a first object in a third image, and at least one of first information input by a user, second information obtained via the at least one sensor in relation to the user, or third information obtained via the at least one sensor in relation to a surrounding environment; obtain, from the deep learning model, a matrix for adjusting a second distance of the at least one object in the second image; obtain a fourth image by adjusting the second distance of the at least one object in the second image based on the matrix; and display, on the display, the fourth image. The deep learning model may be trained by inputting at least one of user information or surrounding environment information, and at least one matrix for adjusting a third distance of a second object and respectively corresponding to at least one of the user information or the surrounding environment information.

The at least one processor may be configured to execute the instructions to cause the wearable electronic device to pre-process the first image by calibrating the distortion area based on a lens type of the camera.

The deep learning model may include a plurality of sub-deep learning models respectively corresponding to a plurality of pieces of information, and the deep learning model may be configured to identify, from among the plurality of sub-deep learning models, at least one sub-deep learning model respectively corresponding to at least one type of information input into the deep learning model from among the first information, the second information, and the third information; and obtain the matrix by sequentially using the at least one sub-deep learning model.

The deep learning model may include a first sub-deep learning model corresponding to the first information, a second sub-deep learning model corresponding to the second information, and a third sub-deep learning model corresponding to the third information. Based on the first information being input into the deep learning model, first output data of the first sub-deep learning model may be used as input data of the second sub-deep learning model or the third sub-deep learning model, and based on the second information being input into the deep learning model, second output data of the second sub-deep learning model may be used as input data of the third sub-deep learning model.

The first information may be input by the user and may include at least one of age information, gender information, height information, eyesight information, or body mass index (BMI) information. The deep learning model may include at least one first sub-deep learning model respectively corresponding to at least one of the age information, the gender information, the height information, the eyesight information, or the BMI information.

The second information may include at least one of interpupillary distance information or pupil color information obtained by the at least one sensor in relation to the user. The deep learning model may include at least one second sub-deep learning model respectively corresponding to at least one of the interpupillary distance information or the pupil color information.

The third information may include at least one of brightness information, GPS information, horizontality information, or inertia information obtained by the at least one sensor in relation to the surrounding environment. The deep learning model may include at least one third sub-deep learning model respectively corresponding to at least one of the brightness information, the GPS information, the horizontality information, or the inertia information.

The deep learning model may be trained based on a default distance table related to a fourth distance of at least one object in a fifth image, and the at least one processor may be configured to execute the instructions to cause the wearable electronic device to obtain the matrix by inputting the default distance table into the deep learning model.

The default matrix may be configured to leave the default distance table unchanged.

The at least one processor may be configured to execute the instructions to cause the wearable electronic device to adjust the second distance by adjusting a pixel value of the second image based on the matrix.

According to an aspect of the disclosure, a control method of a wearable electronic device includes obtaining a first image including at least one object via a camera; obtaining a second image by performing pre-processing the first image based on information related to a type of the camera; inputting, into a deep learning model stored in memory, a default matrix related to a first distance of a first object in a third image, and at least one of first information input by a user, second information obtained by at least one sensor in relation to the user, or third information obtained by the at least one sensor in relation to a surrounding environment; obtaining, from the deep learning model, a matrix for adjusting a second distance of the at least one object in the second image; obtaining a fourth image by adjusting the second distance of the at least one object in the second image based on the matrix; and displaying, on a display, the fourth image. The deep learning model may be trained by inputting at least one of user information or surrounding environment information, and at least one matrix for adjusting a third distance of a second object, the at least one matrix respectively corresponding to at least one of the user information or the surrounding environment information

The obtaining the second image may include pre-processing the first image by calibrating a distortion area based on a lens type of the camera.

The deep learning model may include a plurality of sub-deep learning models respectively corresponding to a plurality of pieces of information, and the obtaining the matrix may include identifying, among the plurality of sub-deep learning models, at least one sub-deep learning model respectively corresponding to at least one type of information input into the deep learning model from among the first information, the second information, and the third information; and obtaining the matrix by sequentially using the at least one sub-deep learning model.

The deep learning model may include a first sub-deep learning model corresponding to the first information, a second sub-deep learning model corresponding to the second information, and a third sub-deep learning model corresponding to the third information, and the obtaining the matrix may include using first output data of the first sub-deep learning model as input data of the second sub-deep learning model or the third sub-deep learning model based on input of the first information into the deep learning model; and using second output data of the second sub-deep learning model as input data of the third sub-deep learning model based on input of the second information into the deep learning model.

The first information may be input by the user and may include at least one of age information, gender information, height information, eyesight information, or body mass index (BMI) information, and the deep learning model may include at least one first sub-deep learning model respectively corresponding to at least one of the age information, the gender information, the height information, the eyesight information, or the BMI information.

The second information may include at least one of interpupillary distance information or pupil color information obtained by the at least one sensor in relation to the user, and the deep learning model may include at least one second sub-deep learning model respectively corresponding to at least one of the interpupillary distance information or the pupil color information.

The third information may include at least one of brightness information, GPS information, horizontality information, or inertia information obtained by the at least one sensor in relation to the surrounding environment, and the deep learning model may include at least one third sub-deep learning model respectively corresponding to at least one of the brightness information, the GPS information, the horizontality information, or the inertia information.

The deep learning model may be trained based on a default distance table related to a fourth distance of at least one object in a fifth image, and the obtaining the matrix may include inputting the default distance table into the deep learning model.

The default matrix may be configured to leave the default distance table unchanged.

According to an aspect of the disclosure, a non-transitory computer-readable recording medium has instructions recorded thereon, that, when executed by one or more processors, may cause the one or more processors to obtain a first image including at least one object via a camera; obtain a second image by performing pre-processing the first image based on information related to a type of the camera; input, into a deep learning model stored in memory, a default matrix related to a first distance of a first object in a third image, and at least one of first information input by a user, second information obtained by at least one sensor in relation to the user, or third information obtained by the at least one sensor in relation to a surrounding environment; obtain, from the deep learning model, a matrix for adjusting a second distance of the at least one object in the second image; obtain a fourth image by adjusting the second distance of the at least one object in the second image based on the matrix; and display, on a display, the fourth image. The deep learning model may be trained by inputting at least one of user information or surrounding environment information, and at least one matrix for adjusting a third distance of a second object, the at least one matrix respectively corresponding to at least one of the user information or the surrounding environment information

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a block diagram illustrating an electronic device in a network environment according to an embodiment;

FIG. 2 is a perspective view of an electronic device according to an embodiment;

FIG. 3A is a first perspective view of an internal configuration of an electronic device according to an embodiment;

FIG. 3B is a second perspective view of an internal configuration of an electronic device according to an embodiment;

FIG. 4 is an exploded perspective view of an electronic device according to an embodiment;

FIG. 5 is a perspective view of an electronic device according to an embodiment;

FIG. 6 is a flowchart illustrating an operation of adjusting a distance of an object included in a 3D image of a wearable electronic device according to an embodiment of the disclosure;

FIG. 7 is a diagram illustrating a configuration based on a function of a wearable electronic device according to an embodiment of the disclosure;

FIG. 8 is a diagram illustrating an operation of adjusting a distance of an object included in a 3D image based on a 3D image mode of a wearable electronic device according to an embodiment of the disclosure;

FIG. 9 is a diagram illustrating a deep learning model according to an embodiment of the disclosure;

FIG. 10 is a diagram illustrating a deep learning model in detail according to an embodiment of the disclosure;

FIG. 11 is a diagram illustrating a training method of a deep learning model according to an embodiment of the disclosure;

FIG. 12 is a diagram illustrating an operation of adjusting a distance of an object included in a 3D image of a wearable electronic device according to an embodiment of the disclosure; and

FIG. 13 is a diagram illustrating an operation of adjusting a distance of an object included in a 3D image based on a plurality of pieces of information of a wearable electronic device according to an embodiment of the disclosure.

### DETAILED DESCRIPTION

The embodiments described in the disclosure, and the configurations shown in the drawings, are only examples of embodiments, and various modifications may be made without departing from the scope and spirit of the disclosure.

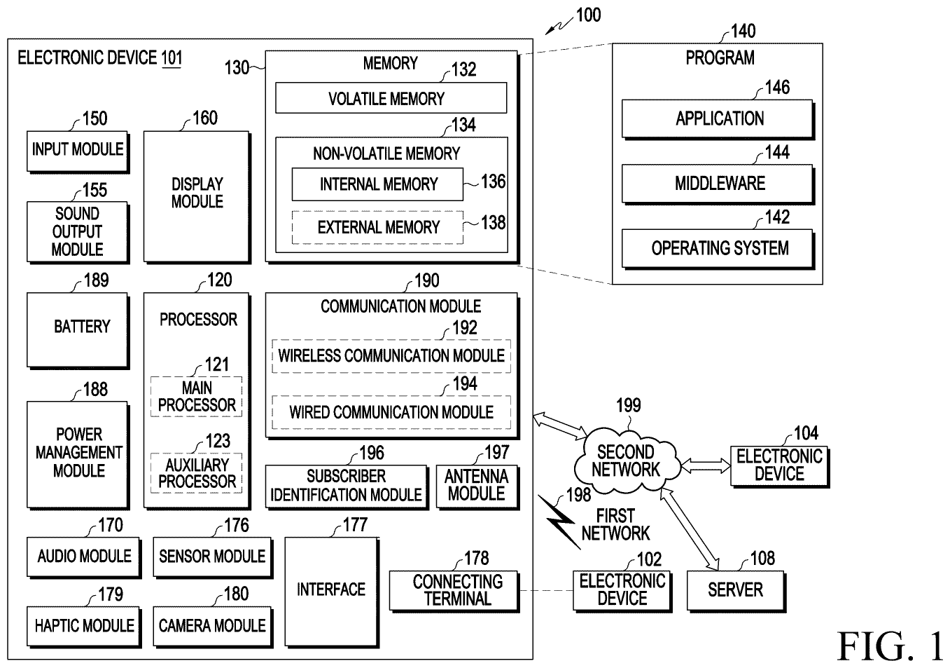

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

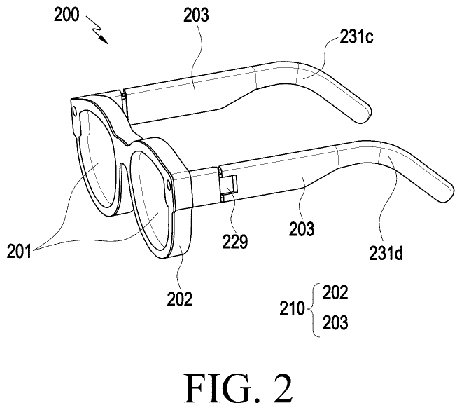

FIG. 2 is a perspective view of an electronic device 200 (e.g., electronic device 101 of FIG. 1) according to an embodiment.

Referring to FIG. 2, the electronic device 200 may be a glasses-type wearable electronic device, and a user who wears the electronic device 200 may visually perceive things or environments around the user. For example, the electronic device 200 may be a head-mounted device (HMD) or smart glasses capable of providing an image immediately before the eyes of the user. The configuration of the electronic device 200 of FIG. 2 may have the same configuration as the configuration of the electronic device 101 of FIG. 1.

According to an embodiment, the electronic device 200 may include a housing 210 that forms the appearance of the electronic device 200. The housing 210 may provide a space where the components of the electronic device 200 are disposed. For example, the housing 210 may include a lens frame 202 and at least one wearable member 203.

According to an embodiment, the electronic device 200 may include at least one display member 201 that may provide visual information to a user. For example, the display member 201 may include a module in which a lens, a display, a waveguide or a touch circuit is mounted. According to an embodiment, the display member 201 may be formed transparently or translucently. According to an embodiment, the display member 201 may include a translucent glass material or a window member capable of adjusting light transmittance by adjusting a coloration concentration. According to an embodiment, the display member 201 may be provided in a pair, and thus, in the state in which the electronic device 200 is worn on a user's body, the display members 201 may be disposed to respectively correspond to the left eye and the right eye of the user.

According to an embodiment, the lens frame 202 may accommodate at least a part of the display member 201. For example, the lens frame 202 may enclose at least a part of the edge of the display member 201. According to an embodiment, the lens frame 202 may dispose at least one of the display members 201 in a location corresponding to a user's eye. According to an embodiment, the lens frame 202 may be a rim of a glasses structure. According to an embodiment, the lens frame 202 may include at least one closed line that encloses the display member 201.

According to an embodiment, the wearable member 203 may extend from the lens frame 202. For example, the wearable member 203 may extend from an end part of the lens frame 202, and the wearable member 203 together with the lens frame 202 may be located on or supported by a user's body (e.g., an ear). According to an embodiment, the wearable member 203 may be coupled rotatably with respect to the lens frame 202 via a hinge structure 229. According to an embodiment, the wearable member 203 may include an inner side 231c configured to face a user's body and an outer side 231d that is the opposite side of the inner side.

According to an embodiment, the electronic device 200 may include the hinge structure 229 capable of folding the wearable member 203 toward the lens frame 202. The hinge structure 229 may be disposed between the lens frame 202 and the wearable member 203. When a user does not wear the electronic device 200, the user may carry or keep the electronic device 200 by folding the wearable member 203 toward the lens frame 202 to partially overlap each other.

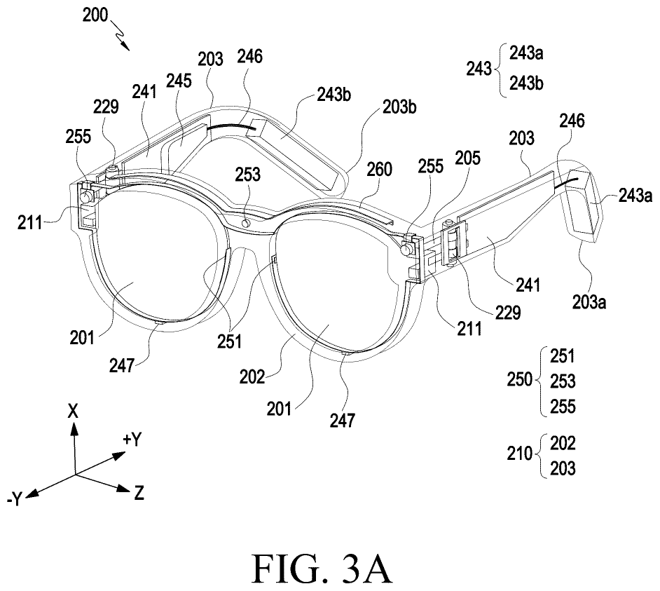

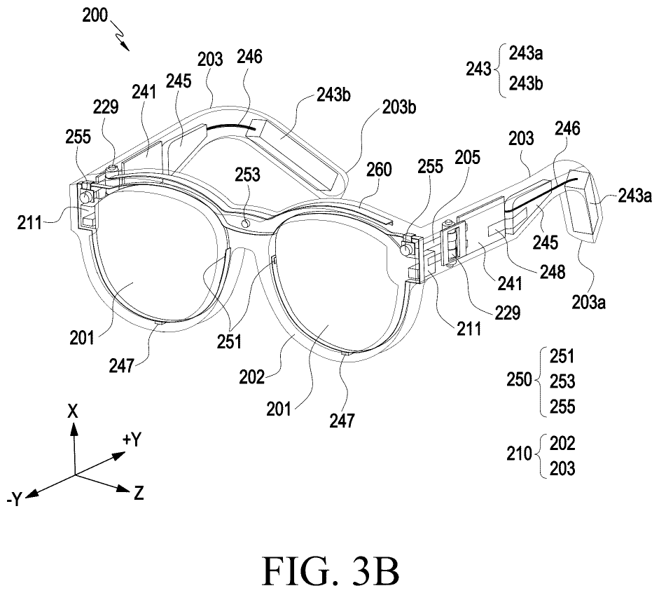

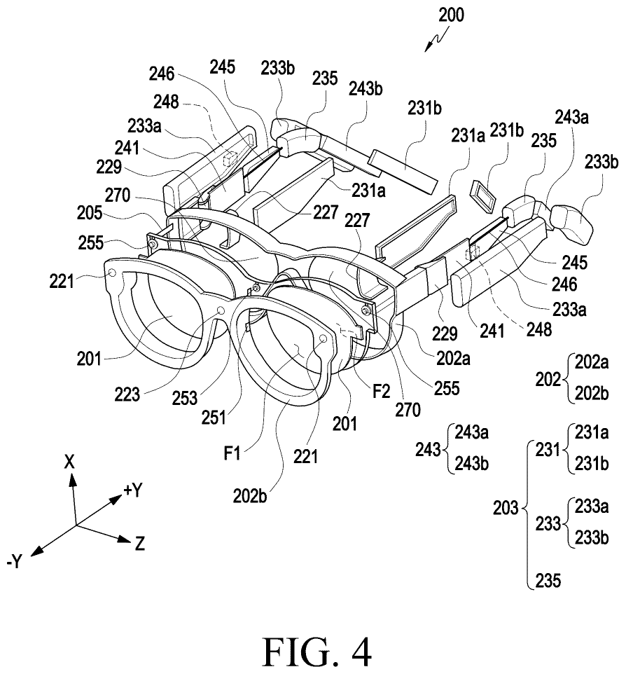

FIG. 3A is a first perspective view of an internal configuration of an electronic device according to various embodiments. FIG. 3B is a second perspective view of an internal configuration of an electronic device according to various embodiments. FIG. 4 is an exploded perspective view of an electronic device according to various embodiments.

Referring to FIG. 3A to FIG. 4, the electronic device 200 may include components (e.g., at least one circuit board 241 (e.g., a printed circuit board (PCB), printed board assembly (PBA), flexible PCB (FPCB), or rigid-flexible PCB (RFPCB)), at least one battery 243, at least one speaker module 245, at least one power transfer structure 246, and a camera module 250) accommodated in the housing 210. The configuration of the housing 210 of FIGS. 3A and 3B may have the same configurations as the configurations of the display member 201, the lens frame 202, the wearable member 203, and the hinge structure 229 of FIG. 2.

According to an embodiment, the electronic device 200 may obtain or recognize a visual image related to a thing or environment in a direction (e.g., −Y direction) in which a user views or the electronic device 200 is oriented by using the camera module 250 (e.g., the camera module 180 of FIG. 1), and may obtain information associated with a thing or environment from an external electronic device (e.g., the electronic device 102 or 104, or the server 108 of FIG. 1) via a network (e.g., the first network 198 of the second network 199 of FIG. 1). According to an embodiment, the electronic device 200 may provide the obtained information associated with a thing or environment to the user in an acoustic or visual form. The electronic device 200 may provide the obtained information associated with a thing or environment to the user in a visual form via the display member 201 by using a display module (e.g., the display module 160 of FIG. 1). For example, the electronic device 200 may embody information related to a thing or environment in a visual form, and combine the same with a real image of an environment around the user, and thus the electronic device 200 may embody an augmented reality.

According to an embodiment, the display member 201 may include a first side (F1) that faces a direction (e.g., −Y direction) of an external incident light, and a second side (F2) that faces the opposite direction (e.g., +Y direction) of the first side (F1). At least part of an image or light incident on the first side (F1) in the state in which a user wears the electronic device 200 may pass through the second side (F2) of the display member 201 disposed to face the left eye or right eye of the user and be incident on the left eye or right eye of the user.

According to an embodiment, the lens frame 202 may include at least two frames. For example, the lens frame 202 may include a first frame 202a and a second frame 202b. According to an embodiment, when a user wears the electronic device 200, the first frame 202a is a frame corresponding to a part that faces the face of the user and the second frame 202b is a part of the lens frame 202 spaced apart from the first frame 202a in a direction of the user' gaze (e.g., −Y direction).

According to an embodiment, a light output module 211 may provide an image to a user. For example, the light output module 211 may include a display panel capable of outputting an image, and a lens that corresponds to the user's eye and guides the image to the display member 201. For example, the user may obtain an image output from the display panel of the light output module 211 via the lens of the light output module 211. According to an embodiment, the light output module 211 may include a device configured to display various types of information. For example, the light output module 211 may include at least one of a liquid crystal display (LCD), a digital mirror device (DMD), a liquid crystal on silicon (LCoS), an organic light emitting diode (OLED), or a micro light emitting diode (micro LED). According to an embodiment, when the light output module 211 or display member 201 includes at least one of an LCD, DMD, or LCoS, the electronic device 200 may include a light source that emits light to a display area of the display member 201 or the light output module 211. According to an embodiment, when the light output module 211 or display member 201 includes one of an OLDE or micro LED, the electronic device 200 may not include a separate light source and provide a virtual image to the user.

According to an embodiment, at least a part of the light output module 211 may be disposed in the housing 210. For example, the light output modules 211 may be disposed in the wearable members 203 or lens frames 202 to respectively correspond to the right eye and the left eye of a user. According to an embodiment, the light output module 211 may be connected to the display member 201, and may provide an image to the user via the display member 201. For example, the image output from the light output module 211 may be incident on the display member 201 via an input optical member located in one end of the display member 201, and may be emitted toward the user's eye via a waveguide and an output optical member located in at least a part of the display member 201. According to an embodiment, the waveguide may be made of glass, plastic, or polymer, and may include a nano pattern formed in one inner or outer surface, for example, a polygonal or curved surface shape grating structure. According to an embodiment, the waveguide may include at least one among at least one diffractive element (e.g., a diffractive optical element (DOE), a holographic optical element (HOE)) or a reflective element (e.g., a reflection mirror)).

According to an embodiment, the circuit board 241 may include components for driving the electronic device 200. For example, the circuit board 241 may include at least one integrated circuit chip, and at least one of the processor 120, the memory 130, the power management module 188, or the communication module 190 of FIG. 1 may be provided in the integrated circuit chip. According to an embodiment, the circuit board 241 may be disposed in the wearable member 203 of the housing 210. According to an embodiment, the circuit board 241 may be electrically connected to the battery 243 via the power transfer structure 246. According to an embodiment, the circuit board 241 may be connected to a flexible printed circuit board 205, and may transfer an electric signal to the electronic components (e.g., the light output module 211, the camera module 250, and a light emitter) of the electronic device via the flexible printed circuit board 205. According to an embodiment, the circuit board 241 may be an interposer board.

According to various embodiments, the flexible printed circuit board 205 may extend from the circuit board 241 to the inside of the lens frame 202 across the hinge structure 229, and may be disposed in at least a part of the outline of the display member 201 inside the lens frame 202.

According to an embodiment, the battery 243 (e.g., the battery 189 of FIG. 1) may be electrically connected to the components (e.g., the light output module 211, the circuit board 241, the speaker module 245, a microphone module 247, or the camera module 250) of the electronic device 200, and may supply power to the components of the electronic device 200.

According to an embodiment, at least a part of the battery 243 may be disposed in the wearable member 203. According to an embodiment, the battery 243 may be disposed to be adjacent to a first end part 203a or a second end part 203b of the wearable member 203. For example, the battery 243 may include a first battery 243a disposed in the first end part 203a of the wearable member 203, and a second battery 243b disposed in the second end part 203b.

According to various embodiments, the speaker module 245 (e.g., the audio module 170 or sound output module 155 of FIG. 1) may convert an electric signal into sound. At least a part of the speaker module 245 may be disposed in the wearable member 203 of the housing 210. According to an embodiment, the speaker module 245 may be disposed in the wearable member 203 to correspond to ears of the user. According to an embodiment (e.g., FIG. 3A), the speaker module 245 may be disposed in the circuit board 241. For example, the speaker module 245 may be disposed between the circuit board 241 and an inner side case (e.g., an inner side case 231 of FIG. 4). According to an embodiment (e.g., FIG. 3B), the speaker module 245 may be disposed beside the circuit board 241. For example, the speaker module 245 may be disposed between the circuit board 241 and the battery 243.

According to an embodiment, the electronic device 200 may include a connection member 248 that connects the speaker module 245 and the circuit board 241. The connection member 248 may transfer, to the circuit board 241, at least part of sound or vibration generated from the speaker module 245. According to an embodiment, the connection member 248 may be formed integrally with the speaker module 245. For example, a part of the extension from the speaker frame of the speaker module 245 may be understood as the connection member 248.

According to an embodiment, the power transfer structure 246 may transfer power of the battery 243 to an electronic component (e.g., a light output module 211) of the electronic device 200. For example, the power transfer structure 246 may be electrically connected to the battery 243 or circuit board 241, and the circuit board 241 may transfer, to the light output module 211, power received from the power transfer structure 246.

According to an embodiment, the power transfer structure 246 may be a configuration capable of transferring power. For example, the power transfer structure 246 may include a flexible printed circuit board or wire. For example, the wire may include a plurality of cables. According to various embodiments, the shape of the power transfer structure 246 may be changed variously in consideration of the number of cables or the types of cables.

According to an embodiment, the microphone module 247 (e.g., the input module 150 or audio module 170 of FIG. 1) may convert sound into an electric signal. According to an embodiment, the microphone module 247 may be disposed in at least a part of the lens frame 202. For example, the at least one microphone module 247 may be disposed in the bottom of the electronic device 200 (e.g., in the direction aligned with the −X-axis) or in the top of the electronic device 200 (e.g., in the direction aligned with the X-axis). According to an embodiment, the electronic device 200 may recognize a user's voice by using voice information (e.g., sound) obtained by the at least one microphone module 247. For example, based on the obtained voice information or additional information (e.g., low-frequency vibration on the user's skin or bones), the electronic device 200 may distinguish voice information and ambient noise. For example, the electronic device 200 may recognize the voice of the user and may perform a function of reducing ambient noise (e.g., noise cancelling).

According to an embodiment, the camera module 250 may capture a still image or a video. The camera module 250 may include at least one of a lens, at least one image sensor, an image signal processor, or a flash. According to an embodiment, the camera module 250 may be disposed in the lens frame 202, and may be disposed around the display member 201.

According to an embodiment, the camera module 250 may include at least one first camera module 251. According to an embodiment, the first camera module 251 may capture the trajectory of a user's eye (e.g., pupil) or gaze. For example, the first camera module 251 may capture a reflection pattern of light that the light emitter emits toward the user's eye. For example, the light emitter may emit light corresponding to an infrared light band for tracking the trajectory of the gaze by using the first camera module 251. For example, the light emitter may include an IR LED. According to an embodiment, the processor (e.g., the processor 120 of FIG. 1) may adjust a location of a virtual image projected onto the display member 201 so that the virtual image corresponds to a direction which the user's pupil gazes at. According to an embodiment, the first camera module 251 may include a global shutter (GS)-based camera, and may track the trajectory of the user's eye or gaze by using a plurality of first camera modules 251 having the same specifications and showing the same performance.

According to various embodiments, the first camera module 251 may periodically or aperiodically transmit, to a processor (e.g., the processor 120 of FIG. 1), information (e.g., trajectory information) related to the trajectory of a user's eye or gaze. According to an embodiment, when a change of the user's gaze is detected (e.g., when the eye makes a movement greater than or equal to a reference movement while the head does not move) based on the trajectory information, the first camera module 251 may transmit trajectory information to the processor.

According to an embodiment, the camera module 250 may include a second camera module 253. According to an embodiment, the second camera module 253 may capture an external image. According to an embodiment, the second camera module 253 may be a global shutter-based camera or a rolling shutter (RS)-based camera. According to an embodiment, the second camera module 253 may capture an external image via a second optical hole 223 formed in the second frame 202b. For example, the second camera module 253 may include a high-definition color camera, and may be a high resolution (HR) or photo video (PV) camera. The second camera module 253 may provide an auto focus (AF) function and an optical image stabilizer (OIS) function.

According to various embodiments, the electronic device 200 may include a flash located to be adjacent to the second camera module 253. For example, when the second camera module 253 obtains an external image, the flash may provide light for increasing the brightness (e.g., illuminance) around the electronic device 200, and may obtain an image notwithstanding a dark environment, light incident from various light sources, or light reflection.

According to various embodiments, the camera module 250 may include at least one third camera module 255. According to an embodiment, the third camera module 255 may capture a motion of a user via a first optical hole 221 formed in the lens frame 202. For example, the third camera module 255 may capture a gesture (e.g., a hand movement) of the user. The third camera module 255 or the first optical hole 221 may be disposed in both ends of the lens frame 202 (e.g., the second frame 202b), for example, in both end parts of the lens frame 202 (e.g., the second frame 202b) in X direction. According to an embodiment, the third camera module 255 may be a global shutter (GS)-based camera. For example, the third camera module 255 may be a camera that supports 3 degrees of freedom (3 DoF) or 6 DoF, and may provide a 360-degree space (e.g., omni-direction), location, or movement recognition. According to an embodiment, the third camera module 255 is a stereo camera, performing a movement path tracking function (simultaneous localization and mapping (SLAM)) and a user movement recognition function by using a plurality of global shutter (GS)-based cameras having the same specifications and showing the same performance. According to an embodiment, the third camera module 255 may include an infrared (IR) camera (e.g., a time of flight (TOF) camera or structured light camera). For example, the IR camera may operate as at least a part of a sensor module (e.g., the sensor module 176 of FIG. 1) for sensing a distance to a subject.

According to an embodiment, at least one of the first camera module 251 or the third camera module 255 may be replaced with a sensor module (e.g., the sensor module 176 of FIG. 1). For example, a sensor module may include at least one of a vertical cavity surface emitting laser (VCSEL), an infrared ray sensor, or photodiode. For example, the photodiode may include a positive intrinsic negative (PIN) photo diode or an avalanche photo diode (APD). The photo diode may be referred to as a photo detector or a photo sensor.

According to an embodiment, at least one of the first camera module 251, the second camera module 253, or the third camera module 255 may include a plurality of camera modules. For example, the second camera module 253 including a plurality of lenses (e.g., wide-angle and telephoto lenses) and image sensors may be disposed in one side (e.g., a side that faces the −Y-axis) of the electronic device 200. For example, the electronic device 200 may include a plurality of camera modules having different properties (e.g., an angle of view) or different functions, and may perform control to change the angle of view of a camera module based on user's selection or trajectory information. For example, at least one of the plurality of camera modules may be a wide-angle camera and at least one other may be a telephoto camera.

According to various embodiments, a processor (e.g., the processor 120 of FIG. 1) may determine a movement of the electronic device 200 or a movement of a user based on information associated with the electronic device 200 obtained using at least one of a gesture sensor, a gyro sensor, or an acceleration sensor of a sensor module (e.g., the sensor module 176 of FIG. 1) and a motion of the user (e.g., an approach of the user's body to the electronic device 200) obtained using the third camera module 255. According to an embodiment, the electronic device 200 may include a magnetic (geomagnetic) sensor capable of measuring a point of the compass based on a magnetic field and a line of magnetic force, or a hole sensor capable of obtaining movement information (e.g., a movement direction or movement distance) using an intensity of a magnetic field. For example, the processor may determine a movement of the electronic device 200 or a movement of user based on information obtained from the magnetic (geomagnetic) sensor or hole sensor.

According to various embodiments, the electronic device 200 may perform an input function (e.g., a touch or pressure sensing function) capable of interacting with a user. For example, a component (e.g., a touch sensor or a pressure sensor) configured to perform a touch or pressure sensing function may be disposed in at least a part of the wearable member 203. Based on information obtained via the component, the electronic device 200 may control a virtual image output via the display member 201. For example, a sensor related to the touch or pressure sensing function may be configured variously, such as a resistive type sensor, a capacitive type sensor, an electro-magnetic type (EM) sensor, or an optical type sensor. According to an embodiment, the component configured to perform the touch or pressure sensing function may be entirely or partially the same as the input module 150 of FIG. 1.

According to an embodiment, the electronic device 200 may include a stiffening member 260 disposed in an inner space of the lens frame 202 and formed to have higher stiffness than that of the lens frame 202.

According to an embodiment, the electronic device 200 may include a lens structure 270. The lens structure 270 may refract at least part of light. For example, the lens structure 270 may be a prescription lens having a predetermined refractive power. According to an embodiment, the housing 210 may include a hinge cover 227 that may conceal a part of the hinge structure 229. Another part of the hinge structure 229 may be accommodated or concealed between the inner side case 231 and an outer side case 233, which will be described below.

According to various embodiments, the wearable member 203 may include the inner side case 231 and the outer side case 233. The inner side case 231 may be, for example, a case configured to face a user's body or directly be in contact with the user's body, and may be made of a low heat conductive material, for example, synthetic resin. According to an embodiment, the inner side case 231 may include an inner side (e.g., the inner side 231c of FIG. 2) that faces the user's body. The outer side case 233 may include, for example, a heat conductive material (e.g., a metal material) at least partially, and may be coupled with the inner side case 231 to face to each other. According to an embodiment, the outer side case 233 may include an outer side (e.g., the outer side 231d of FIG. 2) that is opposite to the inner side 231c. According to an embodiment, at least one of the circuit board 241 or the speaker module 245 may be accommodated in a space separated from the battery 243 within the wearable member 203. In the illustrated embodiment, the inner side case 231 may include a first case 231a including the circuit board 241 or the speaker module 245, and a second case 231b that accommodates the battery 243, and the outer side case 233 may include a third case 233a coupled with the first case 231a to face to each other and a fourth case 233b coupled with the second case 231b to face to each other. For example, the first case 231a and the third case 233a are coupled (hereinafter, “the first case part 231a and 233a”) to accommodate the circuit board 241 or speaker module 245, and the second case 231b and the fourth case 233b are coupled (hereinafter, “the second case part 231b and 233b”) to accommodate the battery 243.

According to an embodiment, the first case part 231a and 233a is coupled rotatably with the lens frame 202 via the hinge structure 229, and the second case part 231b and 233b may be connected to or mounted in the end part of the first case part 231a and 233a via the connection structure 235. According to an embodiment, a part of the connection structure 235 that is in contact with a user's body may be made of a low heat conductive material, for example, silicone, polyurethane, or an elastic material such as rubber, and a part that is not in contact with the user's body may be made of a high heat conductive material (e.g., a metal material). For example, when heat is generated from the circuit board 241 or battery 243, the connection structure 235 may block transferring heat to the part that is in contact with the user's body, and may dissipate or release heat via the part that is not in contact with the user's body. According to an embodiment, the part of the connection structure 235 that is configured to be in contact with the user's body may be understood as a part of the inner side case 231, and the part of the connection structure 235 that is configured not to be in contact with the user's body may be understood as a part of the outer side case 233. According to an embodiment, the first case 231a and the second case 231b may be configured integrally without the connection structure 235, and the third case 233a and the fourth case 233b may be configured integrally without the connection structure 235. According to various embodiments, another component (e.g., the antenna module 197 of FIG. 1) may be further included, and information associate with a thing or environment may be provided from an external electronic device (e.g., the electronic device 102 or 104, or the server 108 of FIG. 1) by using the communication module 190 via a network (e.g., the first network 198 or the second network 199 of FIG. 1).

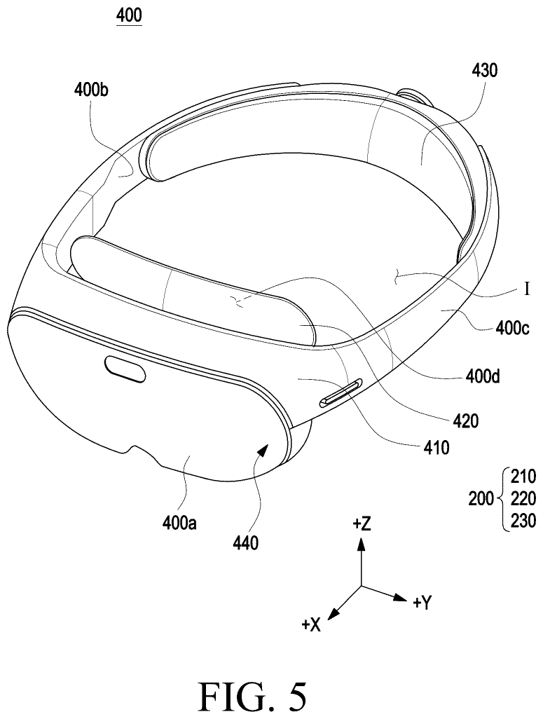

FIG. 5 is another perspective view of an electronic device according to various embodiments of the disclosure.

Referring to FIG. 5, an electronic device 400 may be a head-mounted device (HMD) capable of providing an image before the eyes of a user. The configuration of the electronic device 400 of FIG. 5 may be entirely or partially the same as the configuration of the electronic device 200 of FIG. 2.

According to various embodiments, the electronic device 400 may include a first housing 410, second housing 420, and third housing 430 that forms an appearance of the electronic device 400 and provides a space where components of the electronic device 400 are disposed.

According to various embodiments, the electronic device 400 may include a first housing 410 that encloses at least a part of the head of a user. According to an embodiment, the first housing 410 may include a first side 400a that faces the outside of the electronic device 400 (e.g., −Y direction).

According to various embodiments, the first housing 410 may enclose at least a part of an inner space (I). For example, the first housing 410 may include a second side 400b that faces the inner space (I) of the electronic device 400 and a third side 400c that is the opposite side of the second side 400b. According to an embodiment, the first housing 410 may be coupled with the third housing 430 and may be provided in a closed curve shape that encloses the inner space (I).

According to various embodiments, the first housing 410 may accommodate at least part of the components of the electronic device 400. For example, a light output module (e.g., the light output module 211 of FIG. 3A) and a circuit board (e.g., the circuit board 241 and the speaker module 245 of FIG. 3A) may be disposed in the first housing 410.

According to various embodiments, a single display member 440 may correspond to the left eye and the right eye of the electronic device 400. The display member 440 may be disposed in the first housing 410. The configuration of the display member 440 of FIG. 5 may be entirely or partially the same as the configuration of the display member 201 of FIG. 2.

According to various embodiments, the electronic device 400 may include a second housing 420 that may be safely seated on the face of a user. According to an embodiment, the second housing 420 may include a fourth side 400d that faces at least a part of the face of the user. According to an embodiment, the fourth side 400d may be a side in a direction (e.g., +Y direction) facing the inner space (I) of the electronic device 400. According to an embodiment, the second housing 420 may be coupled with the first housing 410.

According to various embodiments, the electronic device 400 may include a third housing 430 that may be safely seated on the back part of the head of a user. According to an embodiment, the third housing 430 may be coupled with the first housing 410. According to an embodiment, the third housing 430 may accommodate at least part of the components of the electronic device 400. For example, a battery (e.g., the battery 243 of FIG. 3A) may be disposed in the third housing 430.

To enhance a user's usage experience, usage environment, and usability of the head-mounted wearable electronic device, sensations that the user feels and experiences in virtual reality (VR), augmented reality (AR), and mixed reality (MX) spaces may be similar to sensations in a real word.

According to an embodiment, when a distance to a virtual object included in a three-dimensional (3D) image that a user perceives is longer or shorter than a distance between the user and a real object in a real space, satisfaction of experience may be decreased due to symptoms such as motion sickness, dizziness, emesis, or the like, which may lead to a safety issue such as a collision or falling.

A degree of misperception is different depending on a physical condition or surrounding environment of a user. Hereinafter, the disclosure describes an operation of adjusting a distance of a virtual object included in a 3D image in consideration of user information and surrounding environment information.

The technical subject matter of the document is not limited to the above-mentioned technical subject matter, and other technical subject matters which are not mentioned may be understood by those skilled in the art based on the following description.

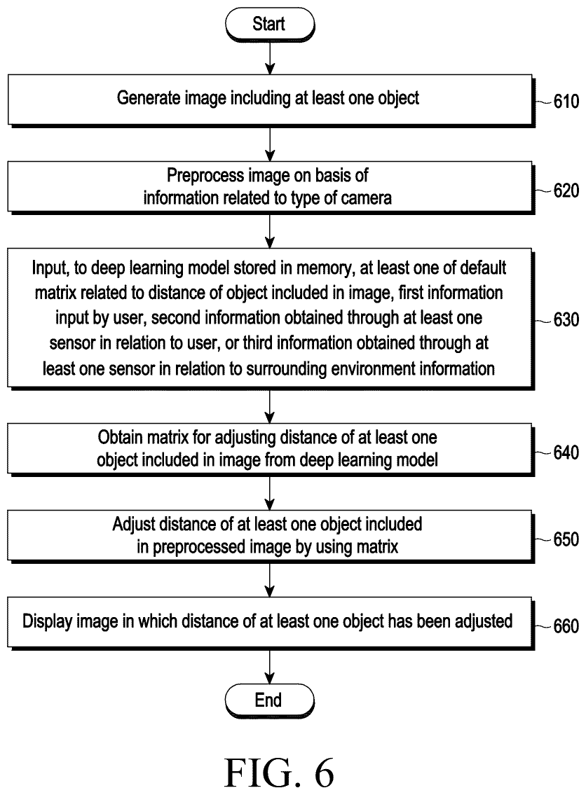

FIG. 6 is a flowchart illustrating an operation of adjusting a distance of an object included in a 3D image of a wearable electronic device according to an embodiment of the disclosure.

Referring to FIG. 6, the wearable electronic device (e.g., the electronic device 101 of FIG. 1, the processor 120 of FIG. 1, the electronic device 200 of FIG. 2, or the electronic device 400 of FIG. 5) may obtain an image including at least one object in operation 610. According to an embodiment, the image may be a 2D image or a 3D image. Hereinafter, a description is provided based on a 3D image for ease of description but an embodiment may be applicable to a 2D image.

According to an embodiment, the electronic device may obtain an image of an external environment via a camera (e.g., the camera module 180 of FIG. 1), and may produce a 3D image including at least one object based on the obtained image. According to an embodiment, the at least one object included in the 3D image may include a virtual object corresponding to a real object disposed in a real space.

According to an embodiment, in operation 620, based on information related to a type of the camera, the wearable electronic device may perform pre-processing that calibrates a distortion area of an image that is generated based on the camera.

According to an embodiment, based on a type of a lens included in the camera, the wearable electronic device may perform pre-processing of the 3D image by calibrating the distortion area generated by the lens.

By pre-processing the 3D image to be normalized irrespective of the type of the camera, misperception based on a difference in the type of the camera included in the wearable electronic device may be reduced.

According to an embodiment, the wearable electronic device may modify a default matrix before inputting the same into a deep learning model to calibrate a distortion area based on the type of the lens included in the camera.

According to an embodiment, in operation 630, the wearable electronic device may input, into the deep learning model stored in memory, at least one of a default matrix related to a distance of an object included in a 3D image, first information input by a user, second information obtained via at least one sensor (e.g., the sensor module 176 of FIG. 1) in relation to the user, or third information obtained via at least one sensor in relation to surrounding environment information.

According to an embodiment, the default matrix related to a distance of an object included in a 3D image may be a warping matrix to calibrate a difference between a distance of an object included in a 3D image and a distance misperceived by a user.

According to an embodiment, the deep learning model may be trained by inputting at least one of user information or surrounding environment information, and at least one matrix for object distance adjustment that respectively corresponds to at least one of the user information or surrounding environment information. According to an embodiment, a matrix input for training the deep learning model may be a matrix statistically obtained based on a plurality of pieces of user information or surrounding environment information.

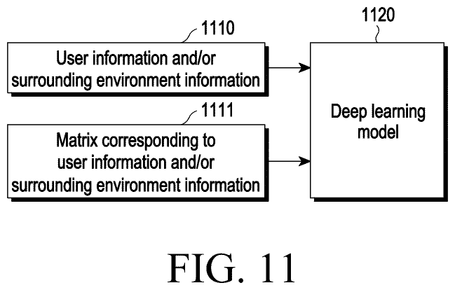

An example of training the deep learning model according to an embodiment will be described with reference to FIG. 11.

According to an embodiment, the deep learning model may include a plurality of sub-deep learning models respectively corresponding to a plurality of pieces of information. According to an embodiment, the deep learning model may identify, from among the plurality of sub-deep learning models, at least one sub-deep learning model respectively corresponding to at least one information input into the deep learning model among the first information, second information, and third information, and may obtain a matrix by sequentially using the at least one sub-deep learning model.

According to an embodiment, a matrix obtained as output data of the deep learning model may be a warping matrix obtained by adjusting the default matrix based on user information or surrounding environment information.

According to an embodiment, the deep learning model may be in a multi-stage regression structure that sequentially uses the plurality of sub-deep learning models.

According to an embodiment, the deep learning model may include a first sub-deep learning model corresponding to the first information, a second sub-deep learning model corresponding to the second information, and a third sub-deep learning model corresponding to the third information.

According to an embodiment, the deep learning model may obtain a matrix by using a deep learning model corresponding to information that the wearable electronic device may obtain. According to an embodiment, the deep learning model may obtain a matrix by using sub-deep learning models in the order of a sub-deep learning model corresponding to the first information that the wearable electronic device may obtain, a sub-deep learning model corresponding to the second information, and a sub-deep learning model corresponding to the third information.

According to an embodiment, based on input of the first information into the deep learning model, the deep learning model may use output data of the first sub-deep learning model as input data of the second sub-deep learning model or the third sub-deep learning model.

According to an embodiment, when the first information and the second information are input into the deep learning model, the deep learning model may use output data obtained via the first sub-deep learning model as input data of the second sub-deep learning model.

According to an embodiment, when the first information and the third information are input into the deep learning model, the deep learning model may use output data obtained via the first sub-deep learning model as input data of the third sub-deep learning model.

According to an embodiment, based on input of the second information into the deep learning model, the deep learning model may use output data of the second sub-deep learning model as input data of the third sub-deep learning model.

According to an embodiment, when the second information and the third information are input into the deep learning model, the deep learning model may use output data obtained via the second sub-deep learning model as input data of the third sub-deep learning model.

According to an embodiment, when the first information to the third information are input into the deep learning model, the deep learning model may use output data obtained via the first sub-deep learning model as input data of the second sub-deep learning model, and may use output data of the second sub-deep learning model as input data of the third sub-deep learning model.

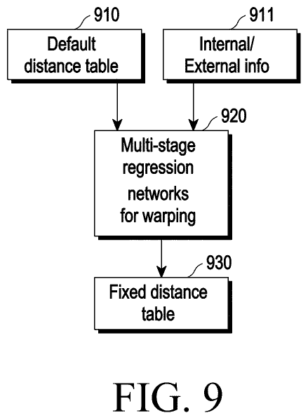

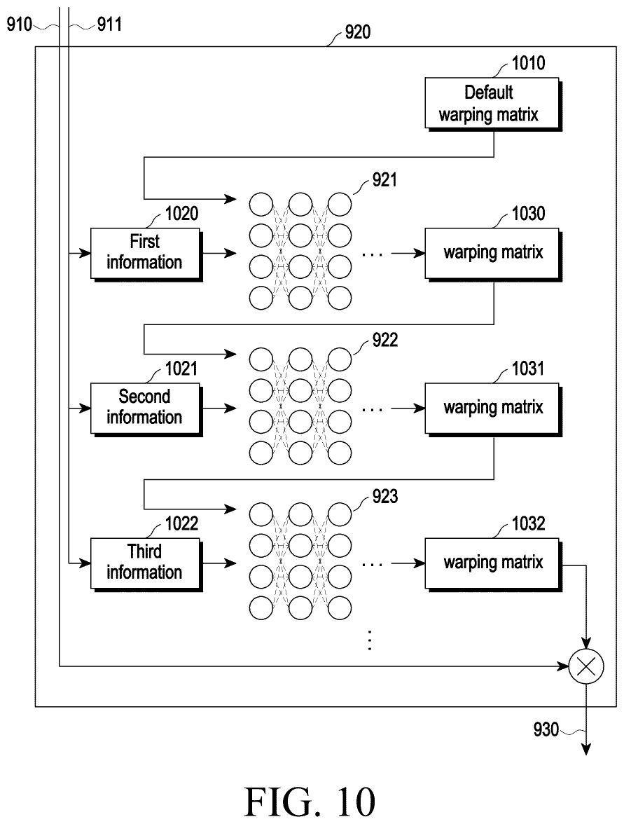

According to an embodiment, the structure of the deep learning model will be described with reference to FIG. 9 and FIG. 10.

According to an embodiment, the deep learning model may determine the order of sub-deep learning models based on the order of information obtained in an experimental manner and capable of improving the accuracy of distance calibration (e.g., information that influences distance calibration).

In the description provided above, the first information input by the user, the second information obtained via at least one sensor in relation to the user, or the third information obtained via at least one sensor in relation to surrounding environment information are described as separate pieces of information, and each information corresponds to a single sub-deep learning model. However, the first information to the third information may each include a plurality of pieces of information. According to an embodiment, when each of the first information to the third information includes a plurality of pieces of information, there may be a plurality of sub-deep learning models respectively corresponding to the plurality of pieces of information.

According to an embodiment, the first information may include at least one of an age, gender, height, eyesight, or body mass index (BMI) input by the user. According to an embodiment, the deep learning model may include at least one first sub-deep learning model respectively corresponding to at least one of the age, gender, height, eyesight, or BMI input by the user. According to an embodiment, each of the at least one first sub-deep learning model may be trained by inputting the at least one of the age, gender, height, eyesight, or BMI, and a matrix that corresponds to each of the at least one of the age, gender, height, eyesight, or BMI.

According to an embodiment, the deep learning model may include at least one first sub-deep learning model corresponding to at least two of the age, gender, height, eyesight, or BMI input by the user.

According to an embodiment, the wearable electronic device may input a gesture with a hand or an external device, or may input user information using an external interoperable device (e.g., input via a touch screen of a smartphone).

According to an embodiment, when an interpupillary distance or a pupil color, which is obtainable by a sensor, is also input by the user, the information may be included in the first information, and an astigmatism level or a weight input by the user may also be included.

According to an embodiment, the second information may include at least one of an interpupillary distance, a pupil size, or a pupil color obtained by at least one sensor.

According to an embodiment, the deep learning model may include at least one second sub-deep learning model respectively corresponding to at least one of the interpupillary distance, pupil size, or pupil color obtained by the at least one sensor in relation to the user. According to an embodiment, each of the at least one second sub-deep learning model may be trained by inputting at least one of the interpupillary distance, pupil size, or pupil color, and a matrix corresponding to each of the at least one of the interpupillary distance, pupil size, or pupil color.

According to an embodiment, the deep learning model may include at least one second sub-deep learning model corresponding to the interpupillary distance, pupil size, or pupil color.

According to an embodiment, the wearable electronic device may obtain the at least one of an interpupillary distance, pupil size, or pupil color of the user via an image sensor (e.g., a camera).

According to an embodiment, the third information may include at least one of brightness, Global Positioning System (GPS) information, horizontality information, or inertia information obtained by at least one sensor in relation to a surrounding environment.

According to an embodiment, the deep learning model may include at least one third sub-deep learning model respectively corresponding to at least one of the brightness, GPS, horizontality information, or inertia information obtained by the at least one sensor in relation to the surrounding environment. According to an embodiment, each of the at least one third sub-deep learning model may be trained by inputting at least one of the brightness, GPS, horizontality information, or inertia information, and a matrix that corresponds to each of the brightness, GPS, horizontality information, or inertia information.

According to an embodiment, the deep learning model may include at least one third sub-deep learning model corresponding to at least two of the brightness, GPS, horizontality information, or inertia information.

According to an embodiment, the wearable electronic device may obtain at least one of the brightness, GPS, horizontality information, or inertia information via an illumination sensor, a GPS sensor, or a gyro sensor.

According to an embodiment, the deep learning model may be trained by further using a default distance table related to a distance of at least one object included in a 3D image. According to an embodiment, the default distance table may include a real distance and a virtual distance that are 1:1 mapped.

According to an embodiment, when the deep learning model is trained using the default distance table as input data, the electronic device may obtain a matrix by further inputting a default distance table to the deep learning model.

According to an embodiment, a default matrix may not change the default distance table. According to an embodiment, the default matrix may be configured by a manufacturer based on the type of the camera of the wearable electronic device, and may calibrate a distortion caused by a lens.

According to an embodiment, an example of training the deep learning model will be described in detail with reference to FIG. 11.

According to an embodiment, in operation 640, the wearable electronic device may obtain, from the deep learning model, a matrix for adjusting the distance of the at least one object included in the image.

According to an embodiment, in operation 650, the wearable electronic device may adjust the distance of the at least one object included in the pre-processed image by using the matrix.

According to an embodiment, the wearable electronic device may multiply (e.g., overlay) the pre-processed image and the matrix obtained from the deep learning model as output data, to adjust the distance of the at least one object included in the pre-processed image.

According to an embodiment, the wearable electronic device may adjust the at distance of the at least one object included in the pre-processed image by adjusting a pixel value of the pre-processed image based on the matrix.

According to an embodiment, in operation 660, the wearable electronic device may display the image in which the distance of the at least one object has been adjusted on a display (e.g., the display module 160 of FIG. 1).

According to an embodiment, the wearable electronic device may obtain user information via an input by the user or by using a sensor before using wearable electronic device, and thus may calibrate a warping matrix by using the deep learning model. According to an embodiment, the wearable electronic device may obtain surrounding environment information via a sensor in real time as the surrounding environment varies, and may calibrate the warping matrix by using the deep learning model.

Based on user information and surrounding environment information, distance calibration of an object included in a 3D image different for each user may be performed, and thus distance misperception by a user may be reduced. Therefore, the usability and the satisfaction of a user in relation to the wearable electronic device may be enhanced.

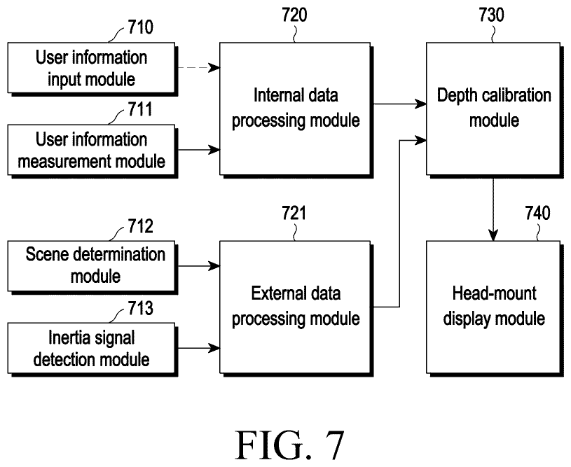

FIG. 7 is a diagram illustrating a configuration based on a function of a wearable electronic device according to an embodiment of the disclosure.

Referring to FIG. 7, the wearable electronic device (e.g., the electronic device 101 of FIG. 1, the processor 120 of FIG. 1, the electronic device 200 of FIG. 2, or the electronic device 400 of FIG. 5) may obtain internal data (e.g., user information) via a user information input module 710 (e.g., the camera module 180 of FIG. 1, the communication module 190 of FIG. 1, or the sensor module 176 of FIG. 1) and a user information measurement module 711 (e.g., the sensor module 176 of FIG. 1). According to an embodiment, the wearable electronic device may obtain external data (e.g., surrounding environment information) via a scene determination module 712 (e.g., the sensor module 176 of FIG. 1) and an inertia signal detection module 713 (e.g., the sensor module 176 of FIG. 1).

According to an embodiment, the internal data may include at least one of an age, gender, race, height, interpupillary distance, pupil size, eyesight, pupil color, or BMI.

According to an embodiment, the external data may include at least one of a surrounding brightness, whether the wearable electronic device is used inside or outside a room, GPS information, horizontality information of the wearable electronic device, or inertia information of the wearable electronic device.

According to an embodiment, the wearable electronic device may obtain user information (e.g., at least one of an age, gender, race, height, interpupillary distance, pupil size, eyesight, pupil color, or BMI) that a user inputs manually via the user information input module 710, and update stored user information.

According to an embodiment, the wearable electronic device may obtain user information (e.g., at least one of an interpupillary distance, pupil size, and pupil color) via the user information measurement module 711, and update stored user information.

According to an embodiment, the wearable electronic device may obtain surrounding environment information (e.g., at least one of brightness or whether it is used inside or outside a room) via the scene determination module 712, and update stored surrounding environment information.

According to an embodiment, the wearable electronic device may obtain surrounding environment information (e.g., GPS information, horizontality information of the wearable electronic device, or inertial information of the wearable electronic device) via the inertia signal detection module 713 whenever at least one of acceleration information or rotation information of the wearable electronic device, and may update stored surrounding environment information.

According to an embodiment, the wearable electronic device may transfer user information obtained via the user information input module 710 and the user information measurement module 711 to an internal data processing module 720 (e.g., the processor 120 of FIG. 1). According to an embodiment, the internal data processing module 720 may identify the obtained user information by type, and may retain the same.

According to an embodiment, the wearable electronic device may transfer user information obtained via the scene determination module 712 and the inertia signal detection module 713 to an external data processing module 721 (e.g., the processor 120 of FIG. 1). According to an embodiment, the external data processing module 721 may identify the obtained surrounding environment information by type, and may retain the same.

According to an embodiment, the wearable electronic device may transfer user information of the internal data processing module 720 and surrounding environment information of the external data processing module 721 to a depth calibration module 730 (e.g., the processor 120 of FIG. 1). The depth calibration module 730 may adjust a distance of an object included in a 3D image by using a warping matrix obtained using a deep learning model stored in memory (e.g., the memory 130 of FIG. 1).

According to an embodiment, the wearable electronic device may display the 3D image in which the distance of the object has been adjusted in a head-mount display module 740 (e.g., the display module 160 of FIG. 1).

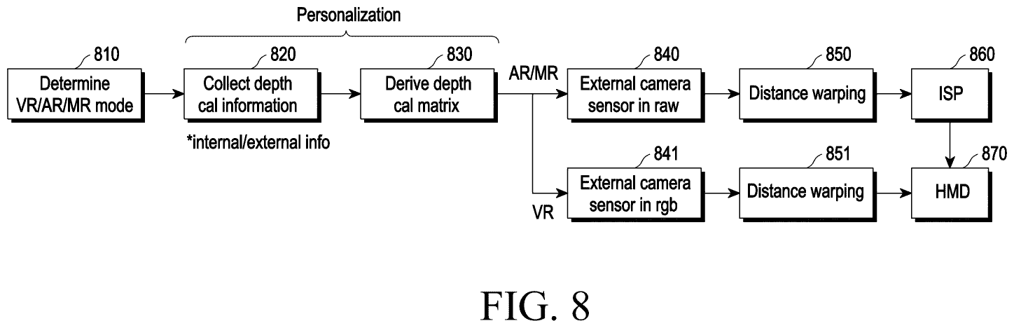

FIG. 8 is a diagram illustrating an operation of adjusting a distance of an object included in a 3D image based on a 3D image mode of a wearable electronic device according to an embodiment of the disclosure.

Referring to FIG. 8, the wearable electronic device (e.g., the electronic device 101 of FIG. 1, the processor 120 of FIG. 1, the electronic device 200 of FIG. 2, or the electronic device 400 of FIG. 5) may determine whether it is in a VR mode, an AR mode, an MR mode in operation 810.

According to an embodiment, the VR mode may be a mode that displays a virtual space different from a real space. According to an embodiment, the AR mode may be a mode that displays a virtual object in a real space viewed via a transparent display or on an image of the real space captured via a camera, and in which a real object included in the real space does not interact with the virtual object. According to an embodiment, the MR mode may be a mode that displays a virtual object in a real space viewed via a transparent display or on an image of the real space captured via a camera, and in which a real object included in the real space interacts with the virtual object.

According to an embodiment, the wearable electronic device may collect information for depth calibration (cal) in operation 820. According to an embodiment, the wearable electronic device may collect internal data (e.g., user information) via the user information input module 710 and user information measurement module 711 of FIG. 7. According to an embodiment, the wearable electronic device may collect external data (e.g., surrounding environment information) via the scene determination module 712 and the inertia signal detection module 713.

According to an embodiment, the wearable electronic device may derive a depth cal matrix in operation 830. According to an embodiment, using a deep learning model, the wearable electronic device may obtain the depth cal matrix (e.g., a warping matrix) for calibrating a difference between a distance of an object included in a 3D image and a distance misperceived by a user. According to an embodiment, an operation of obtaining the depth cal matrix via the deep learning model will be described in detail with reference to FIG. 10.

According to an embodiment, operation 820 of collecting the depth cal information and operation 830 of deriving the depth cal matrix may be personalized for each user when being performed.

According to an embodiment, in the case of the AR mode or MR mode, the wearable electronic device may obtain an image in the raw domain (e.g., bayer) by using an external camera (external camera sensor) (e.g., the camera module 180 of FIG. 1) in operation 840. According to an embodiment, the image may be a 2D image or a 3D image.

According to an embodiment, the wearable electronic device may perform distance calibration (distance warping) by using the depth cal matrix (e.g., a warping matrix) in operation 850. According to an embodiment, when the image is a 2D image, the wearable electronic device may produce a 3D image in which a distance of an object is adjusted by using the depth cal matrix.

According to an embodiment, when the image is a 3D image, the wearable electronic device may adjust a distance of an object included in the 3D image by using the depth cal matrix.

According to an embodiment, before performing distance calibration using the depth cal matrix, the wearable electronic device may perform pre-processing on the 2D image or 3D image by calibrating a distortion based on a type of a lens included in an external camera.

According to an embodiment, when the obtained 3D image is in the raw domain, the wearable electronic device may process the 3D image using an image signal processor (ISP) in operation 860 for display on a head-mounted display (HMD), and may display the same on the HMD in operation 870.

According to an embodiment, in the case of the VR mode, the wearable electronic device may obtain an image in the rgb domain by using an external camera (external camera sensor) (e.g., the camera module 180 of FIG. 1) in operation 841. According to an embodiment, the image may be a 2D image or a 3D image.

According to an embodiment, the wearable electronic device may perform distance calibration (distance warping) by using the depth cal matrix in operation 851. According to an embodiment, when the image is a 2D image, the wearable electronic device may produce a 3D image in which a distance of an object is adjusted by using the depth cal matrix.

According to an embodiment, when the image is a 3D image, the wearable electronic device may adjust a distance of an object included in the 3D image by using the depth cal matrix.

According to an embodiment, before performing distance calibration using the depth cal matrix, the wearable electronic device may perform pre-processing on the 2D image or 3D image by calibrating a distortion based on a type of a lens included in an external camera.

According to an embodiment, when the obtained 3D image is in the rgb domain, the wearable electronic device may display the 3D image on the HMD in operation 870.

The depth cal matrix obtained based on the deep learning model may be used in the same manner in both the raw domain and the rgb domain.

FIG. 9 is a diagram illustrating a deep learning model according to an embodiment of the disclosure.

Referring to FIG. 9, a wearable electronic device (e.g., the electronic device 101 of FIG. 1, the processor 120 of FIG. 1, the electronic device 200 of FIG. 2, or the electronic device 400 of FIG. 5) may input a default distance table 910 and internal/external information 911 (e.g., user information, surrounding environment information) into multi-stage regression networks 920 for warping (e.g., a deep learning model, the depth calibration module 730 of FIG. 7). Hereinafter, for ease of description, the multi-stage regression networks 920 for warping may be referred to as the deep learning model 920.

According to an embodiment, the default distance table 910 may show the mapping between a real distance and a virtual distance at a 1:1 ratio such that a real distance of 1 m is rendered as 1 m, and a real distance of 5 m is rendered as 5 m.

According to an embodiment, the wearable electronic device may obtain a modified distance table (fixed distance table) 930 by multiplying the default distance table 910 and a warping matrix obtained by the deep learning model 920.

According to an embodiment, the structure of the deep learning model 920 will be described with reference to FIG. 10.

FIG. 10 is a diagram illustrating a deep learning model in detail according to an embodiment of the disclosure.

Referring to FIG. 10, a wearable electronic device (e.g., the electronic device 101 of FIG. 1, the processor 120 of FIG. 1, the electronic device 200 of FIG. 2, or the electronic device 400 of FIG. 5) may input the default distance table 910 and the internal/external information 911 (e.g., user information, surrounding environment information) into the deep learning model 920.

According to an embodiment, the deep learning model 920 may be configured as a multi-stage regression structure that optimizes a warping matrix for each stage. According to an embodiment, optimizing a warping matrix for each stage may indicate obtaining a warping matrix improved by applying information input into each of a plurality of sub-deep learning models 921, 922, and 923 via the plurality of sub-deep learning models 921, 922, and 923 included in the deep learning model 920.

According to an embodiment, the internal/external information 911 may include first information 1020, second information 1021, and third information 1022. According to an embodiment, the first information 1020 to third information 1022 may each include an age, gender, race, height, weight, interpupillary distance, eyesight, pupil color, pupil size, BMI, brightness, whether it is used inside/outside a room, GPS information, horizontality information of the wearable electronic device, or inertia information of the wearable electronic device. According to an embodiment, the first information 1020 to third information 1022 may each include at least two of an age, gender, race, height, weight, interpupillary distance, eyesight, pupil color, pupil size, BMI, brightness, whether it is used inside/outside a room, GPS information, horizontality information of the wearable electronic device, or inertia information of the wearable electronic device.

According to an embodiment, the deep learning model 920 may obtain a first warping matrix 1030 by inputting a default warping matrix 1010 and the first information 1020 into the first sub-deep learning model 921.

According to an embodiment, when a user does not want distance calibration, or does not provide any information when distance calibration is performed, or when no change occurs in the surrounding environment, the default warping matrix 1010 may be an identity matrix that does not modify the default distance table.

According to an embodiment, the default warping matrix 1010 is provided by a manufacturer of a camera of the wearable electronic device, and may be a warping matrix that produces a distance table in which a camera lens distortion is calibrated.

According to an embodiment, the default warping matrix 1010 may be a warping matrix statistically derived by collecting a large amount of data. For example, this may be obtained based on a large amount of distance misperception data collected for training the deep learning model. For example, the default warping matrix 1010 may be a warping matrix that adjusts a distance based on the average of distance misperception (depth/distance misperception) of users (a group for data collection) of the wearable electronic device.

According to an embodiment, the deep learning model 920 may obtain a second warping matrix 1031 by inputting the first warping matrix 1030 and the second information 1021 into the second sub-deep learning model 922.

According to an embodiment, the deep learning model 920 may obtain a third warping matrix 1032 by inputting the second warping matrix 1031 and the third information 1022 into the third sub-deep learning model 923.

According to an embodiment, although it is illustrated and described that three sub-deep learning models 921, 922, and 923 are used in FIG. 10, two or fewer sub-deep learning models, or may be four or more sub-deep learning models may be used.

According to an embodiment, the wearable electronic device may obtain, as output data, the modified distance table (fixed distance table) 930 by multiplying the finally obtained third warping matrix 1032 and the input default distance table 910.

According to an embodiment, from among the plurality of sub-deep learning models 921, 922, and 923, the deep learning model 920 may use a sub-deep learning model corresponding to information that a user may provide and information that highly affects the accuracy of distance perception. For example, the wearable electronic device may obtain a warping matrix by using a sub-deep learning model (e.g., the first sub-deep learning model 921) that corresponds to at least one of an age, gender, race, height, weight, interpupillary distance, eyesight, and BMI that may be input by the user.

According to an embodiment, the wearable electronic device may obtain the user's biometric information (e.g., interpupillary distance, pupil color, or pupil size), for distance calibration, via at least one sensor (e.g., the sensor module 176 of FIG. 1) without intervention of the user, and may input the same into the deep learning model 920.

According to an embodiment, the wearable electronic device may obtain surrounding environment information such as brightness, and inertia information of the wearable electronic device via at least one sensor without intervention of the user, and may input the same into the deep learning model 920.

According to an embodiment, when detecting that the user additionally inputs user information or detecting a change of the surrounding environment, the wearable electronic device may input the input user information or measured surrounding environment information into the deep learning model 920.

According to an embodiment, based on the order of existing input information and newly input information, the deep learning model 920 may input a warping matrix of a stage before the newly input information into a sub-deep learning model corresponding to the newly input information.

According to an embodiment, the deep learning model 920 may input a warping matrix output from the sub-deep learning model corresponding to the newly input information, into a sub-deep learning model of a stage after the newly input information, to obtain a final warping matrix to which the newly input information is applied.

A warping matrix may be finely adjusted by sequentially using each piece of information, and thus a warping matrix optimized for the user may be obtained.

Accordingly, the wearable electronic device of the disclosure may provide an enhanced distance perception experience to the user.

FIG. 11 is a diagram illustrating a training method of a deep learning model according to an embodiment of the disclosure.

Referring to FIG. 11, a wearable electronic device (e.g., the electronic device 101 of FIG. 1, the processor 120 of FIG. 1, the electronic device 200 of FIG. 2, or the electronic device 400 of FIG. 5) may input user information or surrounding environment information 1110, and a matrix 1111 corresponding to the user information or surrounding environment information into a deep learning model 1120, to train the deep learning model 1120.

According to an embodiment, the wearable electronic device may input, into the deep learning model 1120, information (e.g., at least one of an age, gender, race, height, weight, interpupillary distance, eyesight, pupil color, pupil size, or BMI) associated with a first user and a matrix for calibrating a degree of misperception of the first user. According to an embodiment, the wearable electronic device may input, into the deep learning model 1120, the surrounding environment information (e.g., at least one of brightness, whether it is used inside/outside a room, GPS information, horizontality information of the wearable electronic device, or inertia information of the wearable electronic device) when the first user uses the wearable electronic device.

According to an embodiment, the electronic device may input, into the deep learning model 1120, multiple user information, surrounding environment information, and a matrix in which a degree of distance misperception of the corresponding user are manually adjusted.

According to an embodiment, the wearable electronic device may further use a default warping matrix as input data for training the deep learning model 1120.

According to an embodiment, the wearable electronic device may further use a default distance table as input data for training the deep learning model 1120.

According to an embodiment, the wearable electronic device may further use information associated with a camera type as input data for training the deep learning model 1120.

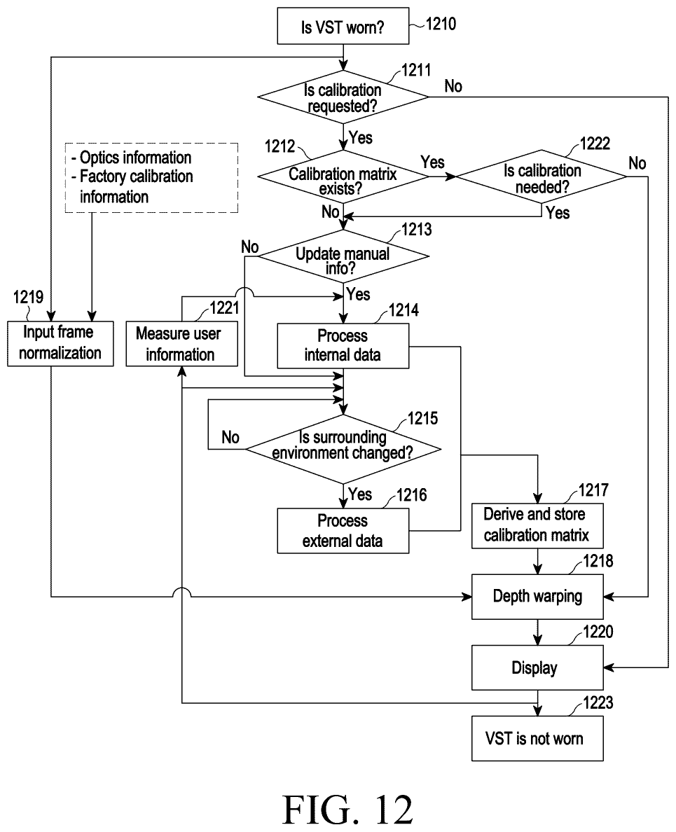

FIG. 12 is a diagram illustrating an operation of adjusting a distance of an object included in a 3D image of a wearable electronic device according to an embodiment of the disclosure.

Referring to FIG. 12, the wearable electronic device (e.g., the electronic device 101 of FIG. 1, the processor 120 of FIG. 1, the electronic device 200 of FIG. 2, or the electronic device 400 of FIG. 5) may detect that a visual see-through (VST) head-mounted display (HMD) is worn in operation 1210.

According to an embodiment, in operation 1211, the wearable electronic device may identify whether calibration is requested. According to an embodiment, when a user requests calibration or when a discrepancy is detected between the user's motion and a displayed 3D image, the wearable electronic device may identify that calibration is requested.

According to an embodiment, when it is identified that calibration is requested (Yes in operation 1211), the wearable electronic device may identify whether a calibration matrix exists in operation 1212. According to an embodiment, when a stored calibration matrix exists, the wearable electronic device may identify that a calibration matrix exists. According to an embodiment, the stored calibration matrix may be a default warping matrix.

According to an embodiment, when the calibration matrix does not exist (No in operation 1212), the wearable electronic device may identify whether manual information is updated in operation 1213. According to an embodiment, the manual information may include user information input by the user.

According to an embodiment, when the manual information is updated (Yes in operation 1213), the wearable electronic device may perform internal data processing in operation 1214. According to an embodiment, the internal data may include user information input by the user or user information measured by a sensor.

According to an embodiment, the wearable electronic device may identify the user information input by the user by type.

According to an embodiment, in operation 1215, the wearable electronic device may identify a change of the surrounding environment. According to an embodiment, the wearable electronic device may identify a change of the surrounding environment by using a sensor.

According to an embodiment, when the manual information is not updated (No in operation 1213), the wearable electronic device may proceed with operation 1215, to identify whether the surrounding environment is changed.

According to an embodiment, when the surrounding environment is changed (Yes in operation 1215), the wearable electronic device may perform external data processing in operation 1216. According to an embodiment, the external data may include the surrounding environment information measured by the sensor.

According to an embodiment, the wearable electronic device may identify the surrounding environment information measured by the sensor by type.

According to an embodiment, when the surrounding environment is not changed (No in operation 1215), the wearable electronic device may return to operation 1215 to check a change of the surrounding environment.

According to an embodiment, in operation 1217, the wearable electronic device may derive and store a calibration matrix. According to an embodiment, the wearable electronic device may obtain a calibration matrix by inputting internal data and external data into a deep learning model (e.g., the multi-stage regression networks 920 for warping or the deep learning model 920 of FIG. 9) in a multi-stage regression structure stored in memory.

According to an embodiment, in operation 1218, the wearable electronic device may perform distance calibration (depth warping, distance warping). According to an embodiment, the wearable electronic device may perform distance calibration (distance warping) of a 3D image based on the calibration matrix.

According to an embodiment, the 3D image in which distance calibration has been performed may be an image in which an input frame normalization is performed in operation 1219. According to an embodiment, the input frame normalization may be a 3D image pre-processing operation. According to an embodiment, the wearable electronic device may pre-process a 3D image obtained via a camera by using optics information (e.g., a lens type or assembly of the camera), manufacturer calibration (factory calibration) information (information associated with calibration of a lens distortion of the camera).

According to an embodiment, in operation 1220, the electronic device may display the 3D image in which the distance information is adjusted on a display (e.g., the display module 160 of FIG. 1).

According to an embodiment, the wearable electronic device may return to operation 1215 after operation 1220, and may monitor a change of the surrounding environment.

According to an embodiment, the wearable electronic device may measure user information via a sensor in operation 1221 after operation 1220. According to an embodiment, the wearable electronic device may proceed with operation 1214, and may classify and store the measured user information by type.

According to an embodiment, when the calibration matrix exists (Yes in operation 1212), the wearable electronic device may identify whether to perform calibration in operation 1222. According to an embodiment, when the user is changed or when a discrepancy between the user's motion and the displayed 3D image is detected, the wearable electronic device may identify that calibration is to be performed.

According to an embodiment, when calibration is not to be performed (No in operation 1222), the wearable electronic device may proceed with operation 1218 and may perform a distance calibration operation by using the stored warping matrix (e.g., the default warping matrix).

According to an embodiment, when the calibration is to be performed (Yes in operation 1222), the wearable electronic device may proceed with operation 1213 and identify whether user information is manually input.

According to an embodiment, when calibration is not requested (No in operation 1211), the wearable electronic device may proceed with operation 1220 and may display the 3D image.

According to an embodiment, in operation 1223, the wearable electronic device may detect that the VST HMD is not worn. According to an embodiment, when detecting that the VST HMD is not worn while displaying an image, the wearable electronic device may terminate a process.

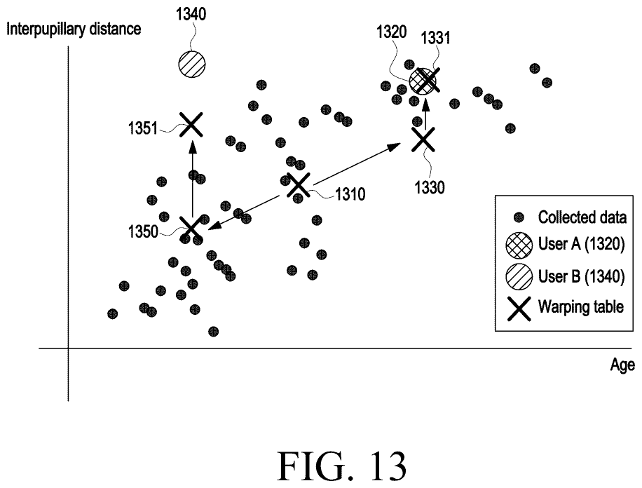

FIG. 13 is a diagram illustrating an operation of adjusting a distance of an object included in a 3D image based on a plurality of pieces of information of a wearable electronic device according to an embodiment of the disclosure. For example, FIG. 13 describes an operation of adjusting a distance of an object included in a 3D image in two dimensions based on an age and an interpupillary distance among a plurality of pieces of information.

Referring to FIG. 13, the wearable electronic device (e.g., the electronic device 101 of FIG. 1, the processor 120 of FIG. 1, the electronic device 200 of FIG. 2, the electronic device 400 of FIG. 5, or the deep learning model 920 of FIG. 9) may perform calibration based on a default warping matrix 1310 obtained based on data collected (collected data, black circles) in advance for distance calibration.

According to an embodiment, the wearable electronic device may use age information, and may use interpupillary distance information, to perform calibration of a warping matrix.

According to an embodiment, the wearable electronic device may input the default warping matrix 1310 and age information of user A into a sub-deep learning model corresponding to age information, to obtain a first warping matrix 1330. According to an embodiment, the wearable electronic device may input the first warping matrix 1330 and the interpupillary distance information of user A into a sub-deep learning model corresponding to interpupillary distance information, to obtain a second warping matrix 1331.

Accordingly, it is identified that the second warping matrix 1331 is similar to a warping matrix 1320 corresponding to user A.

According to an embodiment, the wearable electronic device may input the default warping matrix 1310 and age information of user B into the sub-deep learning model corresponding to age information, to obtain a third warping matrix 1350. According to an embodiment, the wearable electronic device may input the third warping matrix 1350 and the interpupillary distance information of user B into the sub-deep learning model corresponding to interpupillary distance information, to obtain a fourth warping matrix 1351.

Accordingly, it is identified that an error that the fourth warping matrix 1351 has with a warping matrix 1340 corresponding to user B is decreased compared to the default warping matrix 1310.

According to an embodiment, the wearable electronic device regresses in multiple dimensions by using a large amount of information, and an error in a user's distance misperception of an object in a 3D image may be decreased. According to an embodiment, even in the case of a user that deviates from the distributions of multiple users, such as the case of user B, an error in the user's distance misperception of an object in a 3D image may be decreased.

According to an embodiment, a wearable electronic device (e.g., the electronic device 101 of FIG. 1, the processor 120 of FIG. 1, the electronic device 200 of FIG. 2, or the electronic device 400 of FIG. 5) may include a camera (e.g., the camera module 180 of FIG. 1), a display (e.g., the display module 160 of FIG. 1), at least one sensor (e.g., the sensor module 176 of FIG. 1), memory (e.g., the memory 130 of FIG. 1), and at least one processor (e.g., the processor 120 of FIG. 1) operatively connected to the camera, the display, the at least one sensor, and the memory.

According to an embodiment, the at least one processor may obtain an image including at least one object via the camera.

According to an embodiment, the at least one processor may perform pre-processing that calibrates a distortion area of the image that is generated based on the camera, based on information related to a type of the camera.

According to an embodiment, the at least one processor may input, into a deep learning model stored in the memory, at least one of a default matrix (e.g., the default warping matrix 1010 of FIG. 10) related to a distance of an object included in an image, first information input by a user, second information obtained via the at least one sensor in relation to the user, or third information obtained via the at least one sensor in relation to a surrounding environment.

According to an embodiment, the at least one processor may obtain, from the deep learning model, a matrix for adjusting a distance of the at least one object included in the image.

According to an embodiment, the at least one processor may adjust a distance of the at least one object included in the pre-processed image by using the matrix.

According to an embodiment, the at least one processor may display, on the display, the image in which the distance of the at least one object is adjusted.

According to an embodiment, the deep learning model may be trained by inputting at least one of user information or surrounding environment information, and at least one matrix for adjusting a distance of an object and respectively corresponding to at least one of the user information or the surrounding environment information.

According to an embodiment, the at least one processor may pre-process the image by calibrating a distortion area based on a type of a lens included in the camera.

According to an embodiment, the deep learning model may include a plurality of sub-deep learning models respectively corresponding to a plurality of pieces of information.

According to an embodiment, the deep learning model may identify, from among the plurality of sub-deep learning models, at least one sub-deep learning model respectively corresponding to at least one information input into the deep learning model among the first information, the second information, and the third information.

According to an embodiment, the deep learning model may obtain the matrix by sequentially using the at least one sub-deep learning model.

According to an embodiment, the deep learning model may include a first sub-deep learning model corresponding to the first information, a second sub-deep learning model corresponding to the second information, and a third sub-deep learning model corresponding to the third information.

According to an embodiment, the deep learning model may use output data of the first sub-deep learning model as input data of the second sub-deep learning model or the third sub-deep learning model, based on input of the first information into the deep learning model.

According to an embodiment, the deep learning model may use output data of the second sub-deep learning model as input data of the third sub-deep learning model, based on input of the second information into the deep learning model.

According to an embodiment, the first information may include at least one of an age, gender, height, eyesight, or BMI input by the user.

According to an embodiment, the deep learning model may include at least one first sub-deep learning model respectively corresponding to at least one of the age, gender, height, eyesight, or BMI input by the user.

According to an embodiment, the second information may include at least one of an interpupillary distance or a pupil color obtained by the at least one sensor.

According to an embodiment, the deep learning model may include at least one second sub-deep learning model respectively corresponding to at least one of the interpupillary distance or the pupil color obtained by the at least one sensor in relation to the user.

According to an embodiment, the third information may include at least one of brightness, GPS, horizontality information, or inertia information obtained by the at least one sensor in relation to the surrounding environment.

According to an embodiment, the deep learning model may include at least one third sub-deep learning model respectively corresponding to at least one of the brightness, GPS, horizontality information, or inertia information obtained by the at least one sensor in relation to the surrounding environment.

According to an embodiment, the deep learning model may be trained by further using a default distance table related to a distance of at least one object included in an image.

According to an embodiment, the at least one processor may obtain the matrix by further inputting the default distance table into the deep learning model.

According to an embodiment, the default matrix may not change the default distance table.

According to an embodiment, the at least one processor may adjust a pixel value of the pre-processed image based on the matrix, to adjust the distance of the at least one object included in the pre-processed image.

According to an embodiment, a control method by a wearable electronic device may include an operation of obtaining an image including at least one object via a camera.

According to an embodiment, the control method by the wearable electronic device may include an operation of pre-processing the image based on information related to a type of the camera.

According to an embodiment, the control method by the wearable electronic device may include an operation of inputting at least one of a default matrix related to a distance of an object included in an image, first information input by a user, second information obtained by at least one sensor in relation to the user, or third information obtained by the at least one sensor in relation to a surrounding environment, into a deep learning model stored in memory.

According to an embodiment, the control method by the wearable electronic device may include an operation of obtaining, from the deep learning model, a matrix for adjusting a distance of the at least one object included in the image.

According to an embodiment, the control method by the wearable electronic device may include an operation of adjusting a distance of the at least one object included in the pre-processed image by using the matrix.

According to an embodiment, the control method by the wearable electronic device may include an operation of displaying, on a display, the image in which the distance of the at least one object is adjusted.

According to an embodiment, the deep learning model may be trained by inputting at least one of user information or surrounding environment information, and at least one matrix for adjusting a distance of an object and respectively corresponding to at least one of the user information or the surrounding environment information.

According to an embodiment, the operation of pre-processing may pre-process the image by calibrating a distortion area based on a type of a lens included in the camera.

According to an embodiment, the deep learning model may include a plurality of sub-deep learning models respectively corresponding to a plurality of pieces of information.

According to an embodiment, the operation of obtaining the matrix may identify, among the plurality of sub-deep learning models, at least one sub-deep learning model respectively corresponding to at least one information input into the deep learning model among the first information, the second information, and the third information.

According to an embodiment, the operation of obtaining the matrix may obtain the matrix by sequentially using the at least one sub-deep learning model.

According to an embodiment, the deep learning model may include a first sub-deep learning model corresponding to the first information, a second sub-deep learning model corresponding to the second information, and a third sub-deep learning model corresponding to the third information.

According to an embodiment, the operation of obtaining the matrix may use output data of the first sub-deep learning model as input data of the second sub-deep learning model or the third sub-deep learning model, based on input of the first information into the deep learning model.

According to an embodiment, the operation of obtaining the matrix may use output data of the second sub-deep learning model as input data of the third sub-deep learning model, based on input of the second information into the deep learning model.

According to an embodiment, the first information may include at least one of an age, gender, height, eyesight, or BMI input by the user.

According to an embodiment, the deep learning model may include at least one first sub-deep learning model respectively corresponding to at least one of the age, gender, height, eyesight, or BMI input by the user.

According to an embodiment, the second information may include at least one of an interpupillary distance or a pupil color obtained by the at least one sensor.

According to an embodiment, the deep learning model may include at least one second sub-deep learning model respectively corresponding to at least one of the interpupillary distance or the pupil color obtained by the at least one sensor in relation to the user.

According to an embodiment, the third information may include at least one of brightness, GPS, horizontality information, or inertia information obtained by the at least one sensor in relation to the surrounding environment.

According to an embodiment, the deep learning model may include at least one third sub-deep learning model respectively corresponding to at least one of the brightness, GPS, horizontality information, or inertia information obtained by the at least one sensor in relation to the surrounding environment.

According to an embodiment, the deep learning model may be trained by further using a default distance table related to a distance of at least one object included in an image.

According to an embodiment, the operation of obtaining the matrix may obtain the matrix by further inputting the default distance table into the deep learning model.

According to an embodiment, the default matrix may not change the default distance table.

According to an embodiment, the operation of adjusting the distance of the at least one object included in the pre-processed image may adjust a pixel value of the pre-processed image based on the matrix, to adjust the distance of the at least one object included in the pre-processed image.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A wearable electronic device comprising:
a camera;
a display;
at least one sensor;
memory storing instructions; and
at least one processor operatively connected to the camera, the display, the at least one sensor, and the memory, and configured to execute the instructions,
wherein the instructions, when executed by the at least one processor, cause the wearable electronic device to:
obtain a first image comprising at least one object via the camera;
obtain a second image by performing pre-processing that calibrates a distortion area of the first image that is generated based on the camera, based on information related to a type of the camera;
input, into a deep learning model stored in the memory, a default matrix related to a first distance of a first object in a third image, and at least one of:
first information input by a user,
second information obtained via the at least one sensor in relation to the user, or
third information obtained via the at least one sensor in relation to a surrounding environment;
obtain, from the deep learning model, a matrix for adjusting a second distance of the at least one object in the second image;
obtain a fourth image by adjusting the second distance of the at least one object in the second image based on the matrix; and
display, on the display, the fourth image.

2. The wearable electronic device of claim 1, wherein the instructions, when executed by the at least one processor, cause the wearable electronic device to pre-process the first image by calibrating the distortion area based on a type of a lens included in the camera.

3. The wearable electronic device of claim 1, wherein the deep learning model comprises a plurality of sub-deep learning models respectively corresponding to a plurality of pieces of information, and
wherein the deep learning model is configured to:
identify, from among the plurality of sub-deep learning models, at least one sub-deep learning model respectively corresponding to at least one type of information input into the deep learning model from among the first information, the second information, and the third information; and
obtain the matrix by sequentially using the at least one sub-deep learning model.

4. The wearable electronic device of claim 3, wherein the deep learning model comprises a first sub-deep learning model corresponding to the first information, a second sub-deep learning model corresponding to the second information, and a third sub-deep learning model corresponding to the third information,
wherein, based on the first information being input into the deep learning model, first output data of the first sub-deep learning model is used as input data of the second sub-deep learning model or the third sub-deep learning model, and
wherein, based on the second information being input into the deep learning model, second output data of the second sub-deep learning model is used as input data of the third sub-deep learning model.

5. The wearable electronic device of claim 3, wherein the first information is input by the user and comprises at least one of age information, gender information, height information, eyesight information, or body mass index (BMI) information, and
wherein the deep learning model comprises at least one first sub-deep learning model respectively corresponding to at least one of the age information, the gender information, the height information, the eyesight information, or the BMI information.

6. The wearable electronic device of claim 3, wherein the second information comprises at least one of interpupillary distance information or pupil color information obtained by the at least one sensor in relation to the user, and
wherein the deep learning model comprises at least one second sub-deep learning model respectively corresponding to at least one of the interpupillary distance information or the pupil color information.

7. The wearable electronic device of claim 3, wherein the third information comprises at least one of brightness information, Global Positioning System (GPS) information, horizontality information, or inertia information obtained by the at least one sensor in relation to the surrounding environment, and
wherein the deep learning model comprises at least one third sub-deep learning model respectively corresponding to at least one of the brightness information, the GPS information, the horizontality information, or the inertia information.

8. The wearable electronic device of claim 1, wherein the deep learning model is trained by further using a default distance table related to a fourth distance of at least one object in a fifth image, and
wherein the instructions, when executed by the at least one processor, cause the wearable electronic device to obtain the matrix by further inputting the default distance table into the deep learning model.

9. The wearable electronic device of claim 8, wherein the default matrix is configured to maintain the default distance table unchanged.

10. The wearable electronic device of claim 1, wherein the instructions, when executed by the at least one processor, cause the wearable electronic device to adjust the second distance by adjusting a pixel value of the second image based on the matrix.

11. A control method of a wearable electronic device, the control method comprising:
obtaining a first image comprising at least one object via a camera of the wearable electronic device;
obtaining a second image by performing pre-processing the first image based on information related to a type of the camera;
inputting, into a deep learning model stored in memory of the wearable electronic device, a default matrix related to a first distance of a first object in a third image, and at least one of:
first information input by a user,
second information obtained by at least one sensor of the wearable electronic device in relation to the user, or
third information obtained by the at least one sensor in relation to a surrounding environment;
obtaining, from the deep learning model, a matrix for adjusting a second distance of the at least one object in the second image;
obtaining a fourth image by adjusting the second distance of the at least one object in the second image based on the matrix; and
displaying, on a display of the wearable electronic device, the fourth image.

12. The control method of claim 11, wherein the obtaining the second image comprises pre-processing the first image by calibrating a distortion area based on a type of a lens included in the camera.

13. The control method of claim 11, wherein the deep learning model comprises a plurality of sub-deep learning models respectively corresponding to a plurality of pieces of information, and
wherein the obtaining the matrix comprises:
identifying, among the plurality of sub-deep learning models, at least one sub-deep learning model respectively corresponding to at least one type of information input into the deep learning model from among the first information, the second information, and the third information; and
obtaining the matrix by sequentially using the at least one sub-deep learning model.

14. The control method of claim 13, wherein the deep learning model comprises a first sub-deep learning model corresponding to the first information, a second sub-deep learning model corresponding to the second information, and a third sub-deep learning model corresponding to the third information, and
wherein the obtaining the matrix comprises:
using first output data of the first sub-deep learning model as input data of the second sub-deep learning model or the third sub-deep learning model, based on input of the first information into the deep learning model; and
using second output data of the second sub-deep learning model as input data of the third sub-deep learning model, based on input of the second information into the deep learning model.

15. The control method of claim 13, wherein the first information is input by the user and comprises at least one of age information, gender information, height information, eyesight information, or body mass index (BMI) information, and
wherein the deep learning model comprises at least one first sub-deep learning model respectively corresponding to at least one of the age information, the gender information, the height information, the eyesight information, or the BMI information.

16. The control method of claim 13, wherein the second information comprises at least one of interpupillary distance information or pupil color information obtained by the at least one sensor in relation to the user, and
wherein the deep learning model comprises at least one second sub-deep learning model respectively corresponding to at least one of the interpupillary distance information or the pupil color information.

17. The control method of claim 13, wherein the third information comprises at least one of brightness information, Global Positioning System (GPS) information, horizontality information, or inertia information obtained by the at least one sensor in relation to the surrounding environment, and
wherein the deep learning model comprises at least one third sub-deep learning model respectively corresponding to at least one of the brightness information, the GPS information, the horizontality information, or the inertia information.

18. The control method of claim 11, wherein the deep learning model is trained by inputting:
at least one of user information or surrounding environment information, and
at least one matrix for adjusting a third distance of a second object, the at least one matrix respectively corresponding to at least one of the user information or the surrounding environment information.

19. A non-transitory computer-readable recording medium having instructions recorded thereon, that, when executed by one or more processors, cause the one or more processors to:
obtain a first image comprising at least one object via a camera;
obtain a second image by performing pre-processing the first image based on information related to a type of the camera;
input, into a deep learning model stored in memory, a default matrix related to a first distance of a first object in a third image, and at least one of:
first information input by a user,
second information obtained by at least one sensor in relation to the user, or
third information obtained by the at least one sensor in relation to a surrounding environment;
obtain, from the deep learning model, a matrix for adjusting a second distance of the at least one object in the second image;
obtain a fourth image by adjusting the second distance of the at least one object in the second image based on the matrix; and
display, on a display, the fourth image.

20. The wearable electronic device of claim 1, wherein the deep learning model is trained by inputting:
at least one of user information or surrounding environment information, and
at least one matrix for adjusting a third distance of a second object, the at least one matrix respectively corresponding to at least one of the user information or the surrounding environment information.
